(19) United States
(12) Patent Application Publication
(10) Pub. No.: US 2007/0159289 A1
(43) Pub. Date: Jul. 12, 2007

(54) Magnetic core, and inductor and transformer comprising the same

(76) Inventors: Jin-Hyung Lee, Anyang-si (KR); Kyoung-Geun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/584,013

(22) Filed: Oct. 20, 2006

(30) Foreign Application Priority Data
Jan. 6, 2006 (KR) 2006-0001707

(51) Int. Cl. H01F 27/24

(52) U.S. Cl. 336/212

(57) ABSTRACT

The present invention relates to a magnetic core, comprising: a first core and a second core having different shapes and/or materials to realize high current characteristic, high magnetic permeability and high tolerance to temperature changes.

### CROSS-REFERENCE TO RELATED APPLICATIONS

This application claims priority from Korean Patent Application No. 2006-0001707, filed on, Jan. 6, 2006, in the Korean Intellectual Property Office, the disclosure of which is incorporated herein by reference.

### BACKGROUND OF INVENTION

1. Field of Invention

The present invention relates to a magnetic core, and an inductor and a transformer comprising the same, and more particularly, to an E-shaped magnetic core, and an inductor and a transformer comprising the same.

2. Description of the Related Art

A core used for an inductor or a transformer may be classified into a magnetism powder core, that is, a core made of a powder-typed compound metal having magnetism and a ferrite core.

The core is typically made of metal having a high magnetic permeability and is provided in the inside of coils made of a conductive wire to help a magnetic flux or a magnetic field to be formed.

Although the magnetism powder core has a low magnetic permeability and a superior current characteristic, there is a problem that the a unit cost for manufacturing an electronic apparatus comprising the core rises due to its high manufacturing cost.

On the other hand, the ferrite core is relatively cheap and superior in a high frequency characteristic and a loss characteristic, but it has an inferior current characteristic due to its high magnetic permeability.

Accordingly, in the case that only one of the two different cores is used, there is a problem that the core has an inferior current characteristic or needs a high manufacturing cost.

### SUMMARY OF THE INVENTION

It is therefore an object of the invention to provide a magnetic core, and an inductor and a transformer having a superior current characteristic with a low manufacturing cost.

Additional features of the invention will be set forth in the description which follows, and in part will be apparent from the description, or may be learned by practice of the invention.

The foregoing and/or other aspects of the present invention can be achieved by providing a magnetic core, comprising: a first core in the shape of E having a first external leg of a first length; and a second core in the shape of E having a second length longer than the first length, and having a second external leg corresponding to the first external leg.

According to an aspect of the present invention, the first core comprises a magnetism powder material.

According to an aspect of the present invention, the second core comprises ferrite.

According to an aspect of the present invention, the first core comprises alloy including Si, Al, and Fe.

According to an aspect of the present invention, the first core comprises sendust.

According to an aspect of the present invention, the second core comprises a center leg formed between the external legs, and the length of the center leg is shorter than the second length.

According to an aspect of the present invention, the first core and the second core each comprise center legs formed between the two external legs, and the center legs of the first core and the second core are separated from each other.

The foregoing and/or another aspect of the present invention can be achieved by providing an inductor, comprising: the above magnetic core and a coil wound around the magnetic core.

The foregoing and/or another aspect of the present invention can be achieved by providing a transformer, comprising: the above magnetic core; and a coil wound around the magnetic core.

The foregoing and/or another aspects of the present invention can be achieved by providing a magnetic core, comprising: a first core having a plurality of legs having a first length; and a second core having a second length longer than the first length and having a plurality of legs corresponding to the plurality of legs.

According to an aspect of the present invention, the second core comprises a magnetism powder material.

According to an aspect of the present invention, the first core comprises ferrite.

According to an aspect of the present invention, the first core comprises alloy including Si, Al and Fe.

According to an aspect of the present invention, the first core comprises sendust.

The foregoing and/or another aspects of the present invention can be achieved by providing a magnetic core, comprising: a first core; and a second core to be coupled to the first core, and having volume larger than the first core.

According to an aspect of the present invention, the first core comprises a magnetism powder material.

According to an aspect of the present invention, the second core comprises ferrite.

It is to be understood that both the foregoing general description and the following detailed description are exemplary and explanatory and are intended to provide further explanation of the invention as claimed.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a schematic view illustrating a magnetic core according to a first embodiment of the present invention.

FIG. 2 is a sectional view illustrating a magnetic core according to a second embodiment of the present invention.

FIG. 3 is a schematic view illustrating an inductor comprising the magnetic core according to the first embodiment of the present invention.

FIG. 4 is a schematic view illustrating a transformer comprising a magnetic core according to a third embodiment of the present invention.

### DETAILED DESCRIPTION OF THE ILLUSTRATIVE, NON-LIMITING EMBODIMENTS OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

The same elements are given the same reference numerals in various embodiments, and they will be typically described in the first embodiment, and will be omitted in the other embodiments.

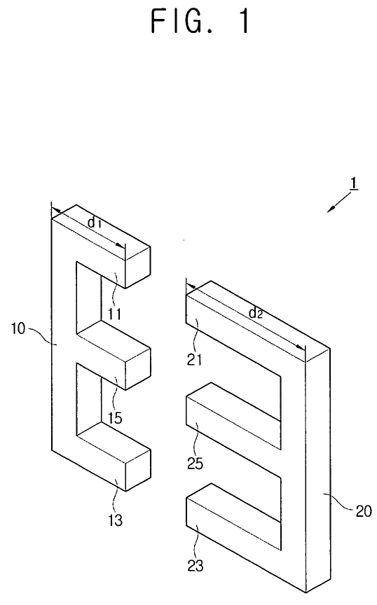

As shown in FIG. 1, a magnetic core 1 comprises a first core 10 and a second core 20 each having the shape of E. The magnetic core 1 is used for an inductor or transformer with legs 11, 13 and 15, 21, 23, and 25 of the first core 10 and the second core 20 to be wound by coils (not shown).

A core usually has a high magnetic permeability. The magnetic permeability exhibited in a normal material such as a paramagnet or a diamagnet is almost 1, and its value changes according to the kind of material, but in a ferromagnet or a ferrimagnet like steel, the magnetic permeability has a very large value. The value varies according to a magnetic hysteresis of a magnetic body or the intensity of the magnetic field. The higher the magnetic permeability is, the larger the magnetism is and the more easily it is influenced by the magnetic field.

The first core 10 and the second core 20 are formed to have an E-shape comprising the side legs 11 and 13, and 21 and 23, and the center legs 15 and 25 formed respectively between the external legs 11 and 13, and 21 and 23. The two cores 10 and 20 face each other so that the respective legs 11, 13 and 15, and 21, 23 and 25 are disposed symmetrically, and may be coupled to each other.

The legs 11, 13 and 15 of the first core 10 have the same length d1, which is shorter than the length d2 of the legs 21, 23 and 25 of the second core 20. The first core 10 according to the present invention is provided as a magnetism powder core comprising a magnetism powder material.

The magnetism powder core is made of sendust which is alloy having a high magnetic permeability and ingredients of about 5% of Al, about 10% of Si, and about 85% of Fe, or made of well known alloy as a brand name ‘kool-μ’ of Magnetics Company. The magnetism powder core has a lower magnetic permeability and a superior current characteristic in comparison with a ferrite core to be described later, but there is a problem that the magnetism powder core increases a manufacturing unit cost of an electronic apparatus comprising the core, as described in the background of the invention.

When a core wound by coils is supplied with an electric current, a magnetic field is generated by an electric field, and a magnetic flux is generated in the core. The magnetic flux density representing magnetism increases in proportion to the electric current and is preferable to keep a certain relation with the electric current while the core reaches a saturated state in which state the core loses the magnetism. The relationship of the magnetic flux density to the electric current is called the “current characteristic” in this specification. In the case that the magnetic flux density increases so rapidly that it reaches the saturated state according to the increase of the electric current, the current characteristic is determined to be inferior. That is, if the core reaches the saturated state easily by a small change of the electric current, it would be difficult to use it for an electronic apparatus. Contrarily, it is determined that the core in which magnetic flux density increases suitably according to the change of the electric current has a superior current characteristic. In general, a core having a high magnetic permeability has an inferior current characteristic.

In addition, it is called a loss characteristic that the magnetic flux density is lost as temperature increases. Having a superior loss characteristic implies a small loss of the magnetic flux density according to the temperature rise.

That is, the first core 10 has a superior current characteristic but is expensive to manufacture, and thus it is a smaller part than the second core 20 in the entire magnetic core 1.

The second core 20 has a similar configuration to the first core 10, and is provided to be opposite to the first core 10. The length d2 of the legs 21, 23 and 25 of the second core 20 is longer than the length d1 of the legs 11, 13 and 15 of the first core 10. Accordingly, the second core 20 has a higher volume than the first core 10.

The second core 20 comprises a ferrite core. The ferrite core is made of an insulating material having a magnetism made by sintering mixture of ferric oxide, zinc oxide, manganese oxide and nickel oxide, and has a high magnetic permeability and a superior loss characteristic. Also, as the ferrite core is easily made into various shapes when sintered, it is widely used as a magnetic core. On the contrary, the ferrite core, in spite of its low price, superior high frequency characteristic and superior loss characteristic, has a disadvantage to have an inferior current characteristic due to its high magnetic permeability.

That is, in the case of the magnetic core 1 according to the present invention, the first core 10 comprising the magnetism powder core and the second core 20 comprising the ferrite core, are combined with each other in a different size. That is, a large part of the magnetic core 1 is formed with the ferrite core of a low price and a small part thereof is formed with the magnetism powder core in order to compensate for the current characteristic.

When a magnetic permeability of the first core 10 is μ1 (about 60 to 130), and a magnetic permeability of the second core 20 is μ2 (about 1000 to 3000), the average magnetic permeability of the entire magnetic core 1 is (μ1+μ2)/2. Accordingly, although the loss of the magnetic permeability may be expected in some degree, it has an advantageous price by using the second core 20 of a low price.

Also, if only the second core 20 is used, a lot of coils must be wound to delay time when the magnetism reaches a saturated state, and the size of the core must be increased in proportion to a lot of coils. However, by the configuration having the second core 20 combined with the first core 10, the magnetic core 1 can be formed with a relatively small volume.

In short, in the case that a lot of coils are required to obtain a large inductance in the magnetic core 1 according to the present invention, a magnetism capacity can be increased at a lower price by increasing the length of the legs 21, 23, and 25 of the second core 20. Also, the magnetic core 1 may be miniaturized by using the first core 10.

The types of the first core 10 and the second core 20 are not limited to the above described embodiment, and may be applied to any kind of material satisfying the characteristics of the respective cores.

Also, the shapes of the cores are not limited to an E-shape and may be applied to any shape if more than two cores can be coupled to each other.

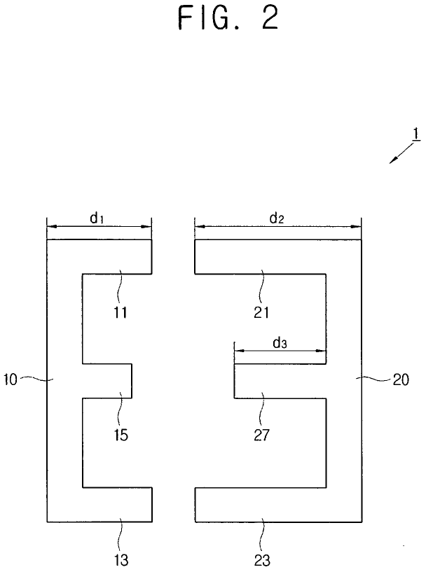

FIG. 2 is a sectional view illustrating a magnetic core according to a second embodiment of the present invention. The center leg 27 of the second core 20 has a different length in comparison with the magnetic core 1 in FIG. 1.

As shown in FIG. 2, the length d3 of the center leg 27 of the second core 20 is shorter than the length d2 of the external legs 21 and 23. Accordingly, between the center leg 15 of the first core 10 and the center leg 27 of the second core 20, there is formed a predetermined space to hold an air layer.

The center legs 15 and 27 of the cores 10 and 20 according to the present embodiment are wound by coils when used for an inductor or a transformer. Then, the gap is formed in between.

The second core 20 provided as a ferrite core has a high magnetic permeability of 1000 to 3000. As described above, the higher magnetic permeability the core has, it will exhibit inferior current characteristic. However, the magnetic permeability can be lowered by forming air between the legs 15 and 27. As the magnetic permeability of air is considered as about 1, the magnetic permeability is substantially lowered by air, thereby improving current characteristics.

The leg forming a gap between the first core 10 and the second core 20 is not limited to the leg 27 of the second core 20, but any leg to be wound by coils may form entirely or partially a gap in between.

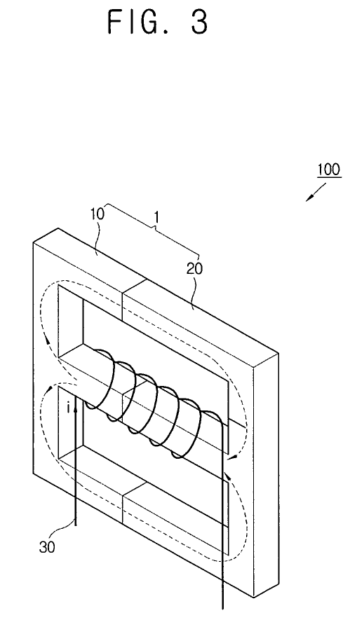

FIG. 3 is a schematic view illustrating an inductor comprising the magnetic core according to the first embodiment of the present invention.

As shown in FIG. 3, an inductor 100 comprises the magnetic core 1 comprising the first core 10 and the second core 20, and a coil 30 wound around the magnetic core 1. One inductor may comprise a plurality of the combination of the core 1 and the coil 30.

In the inductor 100 of the present embodiment, a coil is wound around the center leg of the magnetic core 1. As shown, when an electric current (i) is flowed, a magnetic field is formed along the external leg making a closed loop as illustrated by the dotted lines.

Between the center legs wound by the coil 30, there may be formed an air layer as in the embodiment in FIG. 2.

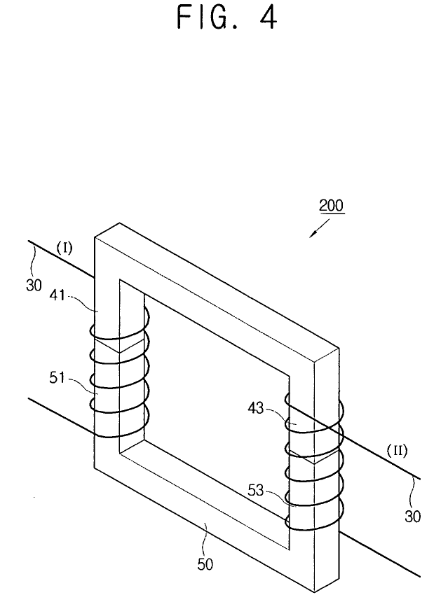

FIG. 4 is a schematic view illustrating a transformer comprising a magnetic core according to a third embodiment of the present invention.

A transformer 200 according to the embodiment shown in FIG. 4, comprises a rectangular magnetic core formed by a first core 40 and a second core 50 each having the shape of □. Also, coils 30 (I) and 30 (II) are wound around the legs 41 and 43, and 51 and 53. The legs 41 and 43, and 51 and 53 are used to couple the first core 40 to the second core 50.

The first core 40 comprises a magnetism powder core, and the second core 50 having a higher volume ratio than the first core 40 comprises a ferrite core. The coil 30 wound around the legs 41 and 51 corresponds to a primary coil (I), and the coil 30 wound around the legs 43 and 53 corresponds to a secondary coil (II). The magnetic field generated by an electric current flowing along the primary coil (I) is induced to the secondary coil (II), and then an induced electromotive force is generated from the secondary coil (II).

The transformer 200 can vary the size of the induced electromotive force or change the voltage by adjusting the turn of the coils; that is, changing the ratio of the turn of the primary coil (I) and the secondary coil (II).

As described above, according to the present invention, there are provided not only a magnetic core but also an inductor and a transformer having a superior current characteristic with a low manufacturing cost.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A magnetic core, comprising:
a first core in the shape of E having a first external leg of a first length; and
a second core in the shape of E having a second length longer than the first length, and having a second external leg corresponding to the first external leg.

2. The magnetic core according to claim 1, wherein the first core comprises a magnetism powder material.

3. The magnetic core according to claim 2, wherein the second core comprises ferrite.

4. The magnetic core according to claim 3, wherein the first core comprises alloy including Si, Al, and Fe.

5. The magnetic core according to claim 3, wherein the first core comprises sendust.

6. The magnetic core according to claim 3, wherein the second core comprises
a center leg formed between the external legs, and
the length of the center leg is shorter than the second length.

7. The magnetic core according to claim 1, wherein the first core and the second core each comprise
center legs formed between the two external legs, and
the center legs of the first core and the second core are separated from each other.

8. An inductor, comprising:
a magnetic core according to claim 1, and
a coil wound around the magnetic core.

9. An inductor, comprising:
a magnetic core according to claim 2, and
a coil wound around the magnetic core.

10. An inductor, comprising:
a magnetic core according to claim 3, and
a coil wound around the magnetic core.

11. A transformer, comprising:
a magnetic core according to claim 1; and
a coil wound around the magnetic core.

12. A transformer, comprising:
a magnetic core according to claim 2, and
a coil wound around the magnetic core.

13. A transformer, comprising:
a magnetic core according to claim 3, and
a coil wound around the magnetic core.

14. A magnetic core, comprising:
a first core having a first plurality of legs having a first length; and
a second core having a second plurality of legs having a second length longer than the first length, the second plurality of legs disposed in an opposing manner to the first plurality of legs.

15. The magnetic core according to claim 14, wherein the first core comprises a magnetism powder material.

16. The magnetic core according to claim 15, wherein the second core comprises ferrite.

17. The magnetic core according to claim 15, wherein the first core comprises alloy including Si, Al and Fe.

18. The magnetic according to claim 15, wherein the first core comprises sendust.

19. A magnetic core, comprising:
a first core; and
a second core to be coupled to the first core, and having volume larger than the first core.

20. The magnetic core according to claim 19, wherein the first core comprises a magnetism powder material.

21. The magnetic core according to claim 20, wherein the second core comprises ferrite.

22. The magnetic core according to claim 20, wherein the first core comprises of an alloy including Si, Al and Fe.

23. The magnetic core according to claim 22, wherein the first core comprises of sendust.

24. The magnetic core according to claim 21, wherein the second core comprises of an insulating material having a magnetism made by sintering mixture of ferric oxide, zinc oxide, manganese oxide and nickel oxide.

25. The magnetic core according to claim 19, wherein the first core and the second core are each E shaped and are coupled to each other in an opposing manner.

26. A magnetic core, comprising:
a first core; and
a second core to be coupled to the first core;
wherein the first core and the second core are made of different materials.

27. The magnetic core according to claim 26, wherein the first core comprises of a magnetism powder material.

28. The magnetic core according to claim 27, wherein the first core comprises of an alloy including Si, Al and Fe.

29. The magnetic core according to claim 28, wherein the first core comprises of sendust.

30. The magnetic core according to claim 27, wherein the second core comprises of ferrite.

31. The magnetic core according to claim 30, wherein the second core comprises of an insulating material having a magnetism made by sintering mixture of ferric oxide, zinc oxide, manganese oxide and nickel oxide.

32. The magnetic core according to claim 30, wherein the first core and the second core are coupled to each other in an opposing manner.

33. The magnetic core according to claim 32, wherein the first core and the second core are each formed in the E shape.

34. The magnetic core according to claim 26, wherein the first core and the second core are coupled to each other in an opposing manner.

35. The magnetic core according to claim 34, wherein the first core and the second core are each formed in the E shape.

36. The magnetic core according to claim 26, wherein the first core and the second core have different shape.

37. The magnetic core according to claim 36, wherein the first core and the second core each have a plurality of legs.

38. The magnetic core according to claim 37, wherein at least one of the plurality of legs of the first core and one of the plurality of legs of the second core are disposed to contact each other.
